(19) United States
(12) Patent Application Publication
(10) Pub. No.: US 2026/0276292 A1
(43) Pub. Date: Sep. 17, 2026

(54) DOOR BODY ASSEMBLY AND REFRIGERATION DEVICE

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Zhanwei Liu, Hefei (CN); Jun Li, Hefei (CN); Huawei Zhang, Hefei (CN); Bo Xie, Hefei (CN)

(21) Appl. No.: 19/161,231

(22) PCT Filed: Nov. 19, 2024
(86) PCT No.: PCT/CN2024/133021

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202411188787.9

(51) Int. Cl. F25D 23/02

(52) U.S. Cl. CPC F25D 23/028; F25D 2500/02

(57) ABSTRACT

A door body assembly for a refrigeration device includes an enclosure door rotatably connected to an enclosure body to open or close a storage space, a door panel slidably disposed on an outer side of the enclosure door, and a driving sliding door mechanism mounted on the enclosure door. The driving sliding door mechanism is connected to both the enclosure door and the door panel and is configured to drive the door panel to move in the width direction of the enclosure door as the enclosure door is rotated relative to the enclosure body. The door panel is thereby able to slide laterally during the opening or closing process, reducing potential interference with nearby obstacles during operation.

### CROSS-REFERENCES TO RELATED APPLICATIONS

The present application claims priority to Chinese Patent Application No. 202323218961.3, filed Nov. 27, 2023, entitled “Refrigerator Hinge”, Chinese Patent Application No. 202410088590.1, filed Jan. 22, 2024, entitled “Door Body Assembly and Refrigeration Device”, Chinese Patent Application No. 202411188787.9, filed Aug. 26, 2024, entitled “Door Body Assembly and Refrigeration Device”, which are hereby incorporated by reference in their entireties.

### FIELD

The present application relates to the field of home appliances, and in particular to a door body assembly and a refrigeration device.

### BACKGROUND

With the increasing demand for the integration of home appliances and home furnishings, embedded design of home appliances has become a trend.

However, to pursue a better home furnishing integration effect, it is sometimes necessary to fix and connect a door panel at a surface of a box door, and higher requirements are placed on gaps between embedded appliances and cabinet side walls to further improve the home furnishing integration effect. If a traditional hinge technology is used after the appliance is embedded in the cabinet, a door body assembly with door panel and the side wall of a mounting space inside the cabinet will interfere during opening and closing of the door, resulting in the door body assembly of the appliance failing to open or close normally.

### BRIEF SUMMARY

The present application provides a door body assembly and a refrigeration device to solve the problem that a door body assembly with door panel may interfere with a side of a mounting space during opening and closing of the door, causing the door body assembly of an appliance to fail to open or close normally.

A door body assembly of embodiments of the present application is for use in a refrigeration device, the refrigeration device including a box body, and the box body is in transmission connection with the door panel through the door body assembly;
the door body assembly includes:
a box door, rotatably connected to the box body, and configured to open or close a storage space of the box body;
a door panel, slidably provided at an outer side of the box door; and
an active slide door mechanism and a traction mechanism, where the active slide door mechanism is provided at the box door, the active slide door mechanism is in transmission connection with the box body through the traction mechanism, and the active slide door mechanism is in transmission connection with the door panel; during opening or closing of the box door, the box body drives the active slide door mechanism through the traction mechanism, and the active slide door mechanism drives the door panel to slide relative to a width direction of the box door.

According to the door body assembly of embodiments of the present application, the active slide door mechanism includes:
a first pedestal, with a first guide rail formed at a side and a second guide rail formed at another side;
a first slider, in transmission connection with the box body through the traction mechanism, and is slidably provided at the first guide rail;
a second slider, connected to the door panel, and slidably provided at the second guide rail; and
a connector, with two ends respectively connected to the first slider and the second slider;
during opening or closing of the box door, the box body drives the first slider to move at the first guide rail through the traction mechanism, and the first slider drives the second slider to move in an opposite direction at the second guide rail through the connector, to drive the door panel to move relative to the box door.

According to the door body assembly of embodiments of the present application, the second slider is provided with a first connect block, and the first connect block is formed with a snap slot for hanging the door panel.

According to the door body assembly of embodiments of the present application, the door body assembly further includes:
a driven slide door mechanism, provided at the box door, including a second pedestal and a third slider; and
the second pedestal is formed with a third guide rail, the third slider is slidably provided at the third guide rail, the third slider is provided with a second connect block, and the second connect block is formed with the snap slot for hanging the door panel.

According to the door body assembly of embodiments of the present application, a top of the door panel is provided with a first hook, a bottom of the door panel is provided with a second hook, and a length of the second hook is greater than a length of the first hook; the first hook and the second hook are configured to insert into each corresponding snap slot.

According to the door body assembly of embodiments of the present application, the door body assembly further includes:
a first end cover, provided at an end of the box door, the first end cover is formed with a first mounting slot, and the active slide door mechanism is provided in the first mounting slot; and
a second end cover, provided at another end of the box door, the second end cover is formed with a second mounting slot, and the driven slide door mechanism is provided in the second mounting slot.

According to the door body assembly of embodiments of the present application, the door body assembly further includes:
a first main decorative cover, detachably provided at the first end cover, formed with a first notch, and an end of the first connect block provided with the snap slot passes through the first notch; and
a second main decorative cover, detachably provided at the second end cover, formed with a second notch, and an end of the second connect block with the snap slot passes through the second notch.

According to the door body assembly of embodiments of the present application, one of the first main decorative cover and the first end cover is provided with a first protrusion, another one is provided with a first slot corresponding to the first protrusion, and the first main decorative cover is detachably connected to the first end cover through the first protrusion and the first slot; and
one of the second main decorative cover and the second end cover is provided with a second protrusion, another one is provided with a second slot corresponding to the second protrusion, and the second main decorative cover is detachably connected to the second end cover through the second protrusion and the second slot.

According to the door body assembly of embodiments of the present application, the connector includes:
a first connector, passing around a first end of the first pedestal, and is connected to a first end of the first slider and a first end of the second slider at two ends respectively; and
a second connector, passing around a second end of the first pedestal and is connected to a second end of the first slider and a second end of the second slider at two ends respectively.

A refrigeration device of embodiments of the present application includes:
a box body, formed with a storage space; and
the door body assembly of any above embodiments, where the box door is rotatably connected to the box body, and is configured to open or close the storage space.

The above one or more technical solutions in embodiments of the present application have at least one of the following technical effects.

According to the door body assembly of embodiments of the present application, the box door is rotatably connected to the box body, and the active slide door mechanism is provided at the box door. The active slide door mechanism is respectively connected to the box body and the door panel. During rotating opening or closing of the box door relative to the box body, the box body drives the active slide door mechanism through the traction mechanism. The active slide door mechanism drives the door panel to slide relative to the box door. During opening of the box door, the door panel is controlled to move outward, and during closing of the box door, the door panel is controlled to move inward. The door panel may avoid obstacles such as walls and objects on the side during closing or opening of the box door, avoiding interference between the door panel and obstacles and affecting the rotation of the box door, to meet the needs of users in different scenarios.

The refrigeration device of embodiments of the present application is provided with the above-mentioned door body assembly, which drives the door panel to slide in the width direction relative to the box door during rotating opening or closing of the box door relative to the box body. The door panel may avoid obstacles such as walls and objects on the side during closing or opening of the box door, avoiding interference between the door panel and obstacles and affecting the rotation of the box door, to meet the needs of users in different scenarios.

Furthermore, by providing the first connect block at the second slider of the active slide door mechanism, and forming a snap slot for hanging the door panel at the first connect block, it is convenient for users to disassemble and assemble the door panel and the box door, meeting the needs of users in different scenarios.

Furthermore, by providing the driven slide door mechanism at the box door, the door panel is supported and assisted in sliding, making sliding of the door panel more stable and smoother.

Furthermore, by providing the second hook and the first hook of different lengths at the top and the bottom of the door panel, when hanging the door panel to the box door, the first hook at the bottom of the door panel may be first inserted into the box door to preliminarily position the door panel, making it easier to align the second hook with the box door slot for mounting.

Furthermore, by placing the first main decorative cover and the second main decorative cover at the first end cover and the second end cover at two ends of the box door, it is possible to cover the active slide door mechanism and the driven slide door mechanism, making the overall appearance of the box door more beautiful.

Additional aspects and advantages of the present application will be set forth in part in the description which follows and, in part, will be apparent from the description, or may be learned by practice of the present application.

### BRIEF DESCRIPTION OF THE DRAWINGS

To provide a clearer explanation of the technical solutions in the embodiments of the present application, a brief introduction will be given to the accompanying drawings required for the description of the embodiments. The drawings in the following description are only some embodiments of the present application, and for those skilled in the art, other drawings may be obtained based on these drawings without any creative effort.

FIG. 1 is a schematic diagram of a refrigeration device with a box door opening outward according to an embodiment of the present application;

FIG. 2 is an exploded view of a refrigeration device according to an embodiment of the present application;

FIG. 3 is a first schematic diagram of an active slide door mechanism according to an embodiment of the present application;

FIG. 4 is a second schematic diagram of an active slide door mechanism according to an embodiment of the present application;

FIG. 5 is an exploded view of an active slide door mechanism according to an embodiment of the present application;

FIG. 6 is a first schematic diagram of a first driven slide door mechanism according to an embodiment of the present application;

FIG. 7 is a second schematic diagram of a first driven slide door mechanism according to an embodiment of the present application;

FIG. 8 is a first schematic diagram of a second driven slide door mechanism according to an embodiment of the present application;

FIG. 9 is a second schematic diagram of a second driven slide door mechanism according to an embodiment of the present application;

FIG. 10 is a schematic diagram of a door panel according to an embodiment of the present application;

FIG. 11 is a schematic diagram of a first hook and a second hook according to an embodiment of the present application;

FIG. 12 is a schematic diagram of a box door, a first end cover, and a second end cover according to an embodiment of the present application;

FIG. 13 is an assembly schematic diagram of a box door, a first end cover, a second end cover, an active slide door mechanism, a driven slide door mechanism, and various hinges according to an embodiment of the present application;

FIG. 14 is a schematic diagram of a first end cover according to an embodiment of the present application;

FIG. 15 is a schematic diagram of a second end cover according to an embodiment of the present application;

FIG. 16 is a schematic diagram of a box door with the need to mount a door panel, according to an embodiment of the present application;

FIG. 17 is a schematic diagram of a box door without the need to mount a door panel according to an embodiment of the present application;

FIG. 18 is a first schematic diagram of a first main decorative cover according to an embodiment of the present application;

FIG. 19 is a second schematic diagram of a first main decorative cover according to an embodiment of the present application;

FIG. 20 is a schematic diagram of a first secondary decorative cover according to an embodiment of the present application;

FIG. 21 is a first schematic diagram of a second main decorative cover according to an embodiment of the present application;

FIG. 22 is a second schematic diagram of a second main decorative cover according to an embodiment of the present application; and

FIG. 23 is a schematic diagram of a second secondary decorative cover according to an embodiment of the present application.

### REFERENCE SIGNS

1: box body; 110: first connect hole; 120: first beam body; 121: second connect hole; 130: second beam body; 131: fourth connect hole; 132: third connect hole;
2: box door; 210: first end cover; 211: first hinge hole; 212: third mounting slot; 213: first mounting slot; 214: first avoid opening; 215: second avoid opening; 216: first mounting hole; 217: first convex edge; 218: third slot; 219: fourth slot; 220: second end cover; 221: guide rail fix seat; 223: second mounting hole; 224: third mounting hole; 225: second convex edge; 227: third convex edge;
4: first hinge; 5: second hinge; 6: third hinge;
7: active slide door mechanism; 701: first fix seat; 702: second fix seat; 703: second adjuster; 704: first adjuster; 705: first bearing; 706: connector; 707: first shaft fix seat; 708, pin shaft; 709: traction rod; 710: second shaft fix seat; 711, connect head; 712: first connect block; 713: second slider; 714: first slider; 715: third bearing; 716: second bearing; 717: first pedestal;
8: first driven slide door mechanism; 801: third fix seat; 802: fourth fix seat; 803: fourth adjuster; 804: third adjuster; 812: second connect block; 813: third slider; 817: second pedestal;
9: second driven slide door mechanism; 901: fifth fix seat; 902: third pedestal; 903: fourth slider; 904: sixth fix seat; 905: third connect block;

13: first main decorative cover; 1301: fifth notch; 1302: fourth notch; 1303: first notch; 1304: third notch; 1305: first snap-fit slot; 1306: second convex rib; 1307: first convex rib;
14: second main decorative cover; 1401: second notch; 1403: fourth convex edge; 1404: sixth convex edge; 1405: second snap-fit slot; 1406: third snap-fit slot; 1407: seventh convex edge; 1408, fifth convex edge;

15: third main decorative cover; 16: fourth main decorative cover; 17: first secondary decorative cover; 18: second secondary decorative cover; 1801: handle part; 19: third secondary decorative cover; 20: fourth secondary decorative cover;
21: door panel; 2111: first hook; 2112: second hook.

### DETAILED DESCRIPTION

Implementations of the present application are further described in detail below in conjunction with accompanying drawings and embodiments. The following embodiments are intended to illustrate the present application, but not to limit the scope of the present application.

In the description of the embodiments of the present application, it is to be noted that the orientation or positional relationships indicated by terms such as “center”, “longitudinal”, “lateral”, “upper”, “lower”, “front”, “rear”, “left”, “right”, “vertical”, “horizontal”, “top”, “bottom”, “inside”, “outside”, etc. are based on the orientation or positional relationship shown in the drawings, and are merely for the convenience of describing the embodiments of the present application and simplifying the description, rather than indicating or implying that the device or component stated must have a particular orientation, is constructed and operated in a particular orientation, and thus is not to be construed as limiting the embodiments of the present application. Moreover, the terms “first”, “second”, “third”, and the like are used for descriptive purposes only and are not to be construed as indicating or implying relative importance.

In the description of embodiments of the present application, it should be noted that, unless otherwise explicitly specified and defined, the terms “connected to” and “connected” shall be understood broadly. For example, it may be either fixedly connected or detachably connected, or may be integrally connected; it may be either mechanically connected, or electrically connected; it may be either directly connected, or indirectly connected through an intermediate medium. The specific meanings of the terms above in embodiments of the present application may be understood by those skilled in the art in accordance with specific conditions.

In embodiments of the present application, unless otherwise clearly stated and defined, the first feature being located “on” or “under” the second feature means that the first feature is in direct contact with the second feature or the first feature is in contact with the second feature by an intervening medium. In addition, the first feature is “on”, “above” and “over” the second feature may refer to that the first feature is directly above or obliquely above the second feature, or simply refer to that the level height of the first feature is higher than that of the second feature. The first feature is “under”, “below” and “beneath” the second feature may refer to that the first feature is directly below or obliquely below the second feature, or simply refer to that the level height of the first feature is lower than that of the second feature.

In the description of this specification, descriptions with reference to the terms “one embodiment”, “some embodiments”, “examples”, “specific examples”, or “some examples” etc. mean that specific features, structure, materials or characteristics described in conjunction with the embodiment or example are included in at least an embodiment or example of the embodiments of the present application. In this specification, the schematic expressions of the above terms do not necessarily refer to the same embodiment or example. Furthermore, the particular features, structures, materials or characteristics described can be combined in any suitable manner in any one or more embodiments or examples. In addition, those skilled in the art may combine the different embodiments or examples described in this specification, as well as the features of the different embodiments or examples, without conflicting each other.

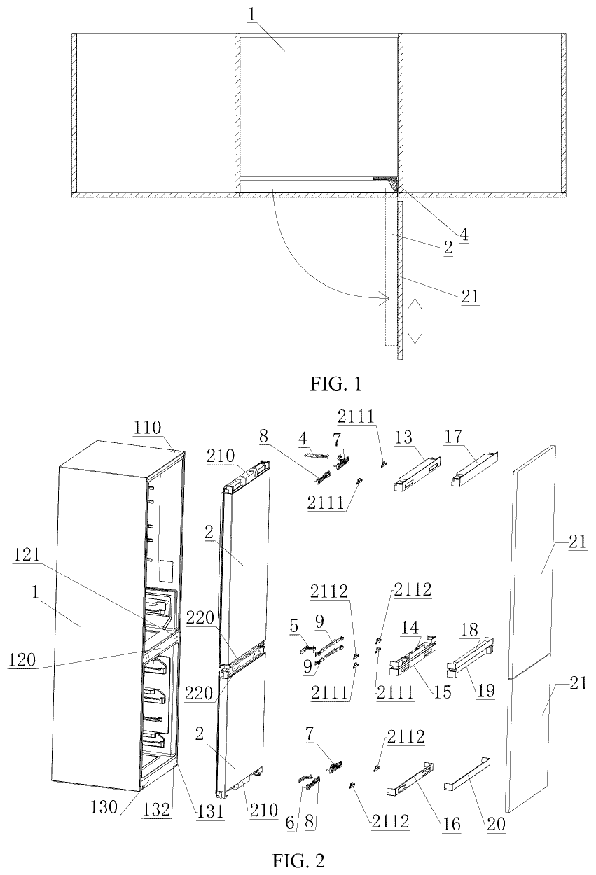

A door body assembly and a refrigeration device of the present application will be described below in conjunction with FIG. 1 to FIG. 23. The door body assembly in the present application may be used for home appliances such as refrigerators, but it should be understood that the door body assembly in the present application may also be used for dishwashers, washing machines, or any other suitable devices. The refrigeration device in the present application is applied, for example, as a refrigerator, but it should be understood that the refrigeration device in the present application may also be applied as a freezer or any other suitable devices.

In an embodiment of the present application, as shown in FIG. 1 and FIG. 2, the door body assembly is for use in a refrigeration device, and the refrigeration device includes a box body 1; the door body assembly includes: a box door 2, rotatably connected to the box body 1, and is configured to open or close a storage space of the box body 1; a door panel 21, slidably provided at an outer side of the box door 2; and an active slide door mechanism 7 and a traction mechanism, where the active slide door mechanism 7 is provided at the box door 2, the active slide door mechanism 7 is in transmission connection with the box body 1 through the traction mechanism, and the active slide door mechanism 7 is in transmission connection with the door panel 21; during opening or closing of the box door 2, the box body 1 drives the active slide door mechanism 7 through the traction mechanism, and the active slide door mechanism 7 drives the door panel 21 to slide relative to a width direction of the box door 2.

The active slide door mechanism 7 may include movable parts such as sliders and slide rails that may slide relative to each other. The two parts that may slide relative to each other are connected to the box door 2 and the door panel 21 through an appropriate connection (such as a bolt connection, and a weld connection, etc.). The active slide door mechanism 7 is connected to the box body 1 through the traction mechanism. In this way, when the box door 2 rotates to open and close, the box body 1 rotates relative to the box door 2, and the active slide door mechanism 7 is driven by the traction mechanism. The active slide door mechanism 7 may drive the door panel 21 to move in the width direction relative to the box door 2 during the rotation of the box door 2 (as shown by the double headed arrow in FIG. 1) to stay as far away as possible from the walls, objects, and other obstacles at a side door of the box body 1, to avoid these obstacles blocking the door panel 21 and affecting the rotation of the box door 2, resulting in the box door 2 being unable to open or close normally.

It may be understood that the width direction of the box door 2 is parallel to a plane in which the box door 2 is located, and perpendicular to a shaft of the box door 2. The door panel 21 may move away from or toward the shaft of the box door 2. It should be noted that the parallel and vertical relationships in the present application require consideration of mounting errors between various components, and both positive and negative 10°errors should be understood within the scope protected by the patent.

In an embodiment, during rotating and opening of the box door 2 toward the outer side of the box body 1 (as indicated by the arc-shaped arrow in FIG. 1), the active slide door mechanism 7 drives the door panel 21 to slide away from the first hinge 4, avoiding interference between the door panel 21 and external obstacles. During rotating and closing of the box door 2 toward a side of the box body 1, the active slide door mechanism 7 drives the door panel 21 to slide toward the first hinge 4, avoiding interference between the closed door panel 21 and obstacles.

According to the door body assembly of embodiments of the present application, the box door 2 is rotatably connected to the box body 1, and the door panel 21 is slidably provided at the outer side of the box door 2. The active slide door mechanism 7 is provided at the box door 2, and the active slide door mechanism 7 is respectively connected to the box door 2 and the door panel 21. During rotating opening or closing of the box door 2 relative to the box body 1, the box body 1 drives the active slide door mechanism 7 through the traction mechanism. The active slide door mechanism 7 drives the door panel 21 to slide in the width direction relative to the box door 2. During opening of the box door 2, the door panel 21 is controlled to move outward, and during closing of the box door 2, the door panel 21 is controlled to move inward. During closing or opening of the box door 2, the door panel 21 may avoid obstacles such as walls and objects on the side, and to avoid interference between the door panel 21 and obstacles that may affect the rotation of the box door 2, to meet the needs of users in different scenarios.

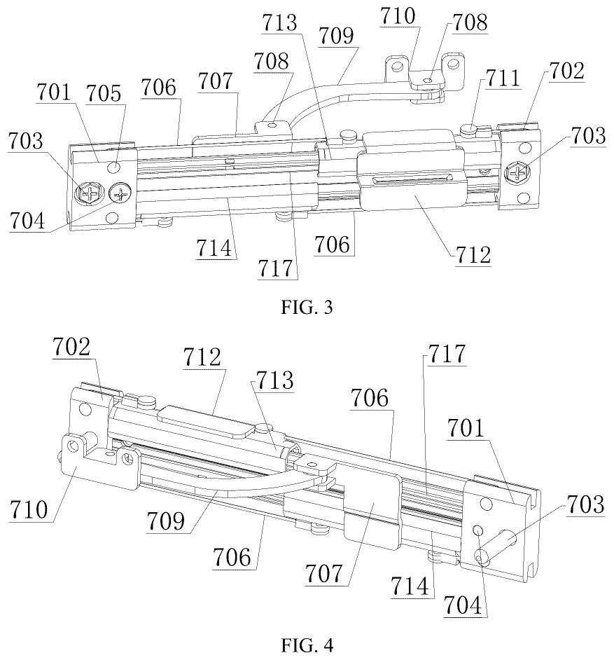

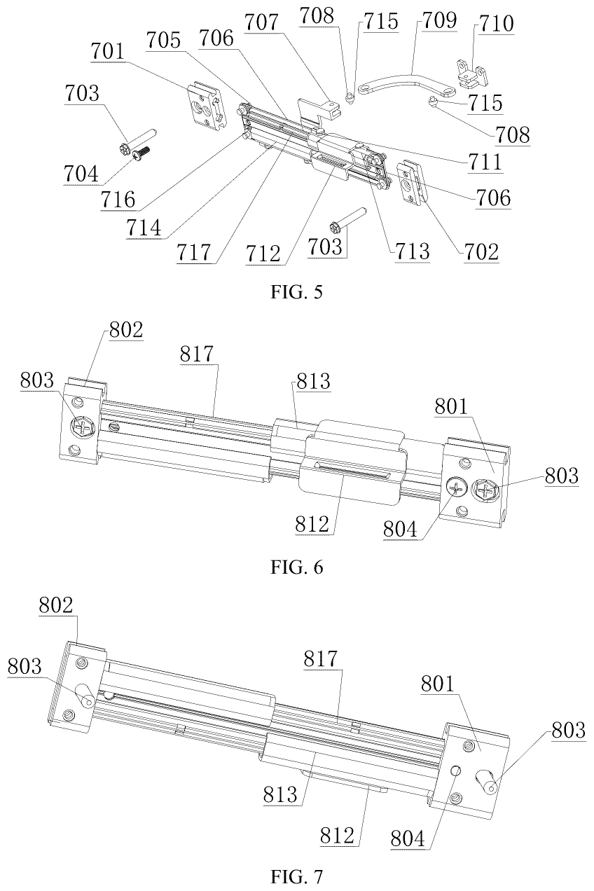

In embodiments of the present application, as shown in FIG. 2, FIG. 3, FIG. 4, and FIG. 5, the active slide door mechanism 7 includes: a first pedestal 717, a first slider 714, and a second slider 713. A side of the first pedestal 717 is formed with a first guide rail, and another side is formed with a second guide rail. The first slider 714 is in transmission connection with the box door 2, and is slidably provided at the first guide rail. The second slider 713 is connected to the door panel 21, and is slidably provided at the second guide rail. Two ends of connector 706 are respectively connected to the first slider 714 and the second slider 713. During opening or closing of the box door 2, the box body 1 drives the first slider 714 to move at the first guide rail through the traction mechanism, and the first slider 714 drives the second slider 713 to move in an opposite direction at the second guide rail through the connector 706, to drive the door panel 21 to move relative to the box door 2.

It should be noted that in practical applications, the design of the first slider 714, the second slider 713, and other sliders in the present application may be flexible and varied to adapt to different work scenarios and performance requirements. They are not limited to specific shapes, sizes, or materials, but may be customized and optimized according to specific needs.

From a material perspective, the first slider 714 and the second slider 713, as well as other sliders in the present application, may be made of materials with high wear resistance, low friction coefficient, and good stability, such as metal alloys, engineering plastics, or special lubricating materials. The selection of these materials aims to improve the durability of the slider, reduce wear and noise during sliding, and ensure smooth sliding.

In terms of structural design, the first slider 714, the second slider 713, and other sliders in the present application may adopt various forms of guide rail contact surfaces, such as planar contact, ball contact, or slide bearing contact. These different contact methods each have their own advantages and disadvantages, for example, ball contact may reduce friction and wear, but the cost is relatively high; planar contact, on the other hand, has a simple structure but may require more frequent lubrication and maintenance. Therefore, when choosing, factors such as usage conditions, cost-effectiveness, and maintenance convenience should be comprehensively considered.

The connector 706 may be a connect part such as a traction rope, a transmission belt, etc. The two ends of the connector 706 are respectively connected to the first slider 714 and the second slider 713. The first slider 714 may drive the second slider 713 to move synchronously, driving the door panel 21 to slide relative to the box door 2.

By reasonably providing an extension direction of the connector 706, the first slider 714 and the second slider 713 move in opposite directions to drive the door panel 21 to avoid obstacles.

In an embodiment, during rotating and opening of the box door 2 toward the outer side of the box body 1, the box body 1 drives the first slider 714 to slide in the direction toward the first hinge 4 through the traction mechanism. The first slider 714 drives the second slider 713 to slide in the opposite direction (i.e., away from the first hinge 4) through the connector 706, avoiding interference between the door panel 21 and external obstacles. During rotating and closing of the box door 2 toward a side of the box body 1, the box body 1 drives the first slider 714 to slide away from the first hinge 4 through the traction mechanism. The first slider 714 drives the second slider 713 to slide in the opposite direction (i.e., toward the first hinge 4) through the connector 706, avoiding interference between the closed door panel 21 and obstacles.

In an embodiment of the present application, as shown in FIG. 4 to FIG. 6, the door body assembly further includes a traction mechanism, and the traction mechanism includes a traction rod 709, a first shaft fix seat 707, and a second shaft fix seat 710. The first shaft fix seat 707 is connected to the first slider 714, and the second shaft fix seat 710 is used to connect to the box body 1. A first end of the traction rod 709 is rotatably connected to the first shaft fix seat 707, and a second end of the traction rod 709 is rotatably connected to the second shaft fix seat 710.

In this embodiment, by fixing the first shaft fix seat 707 and the second shaft fix seat 710 respectively at the first slider 714 and the box body 1, and connecting the first shaft fix seat 707 and the second shaft fix seat 710 through the traction rod 709 therebetween, a distance between the first slider 714 and the second shaft fix seat 710 remains constant. When the box door 2 rotates relative to the box body 1, an angle between the box body 1 and the box door 2 changes, and the first slider 714 is pulled through the transmission connection of the traction rod 709, the first shaft fix seat 707, and the second shaft fix seat 710, causing the first slider 714 to slide at the first pedestal 717 and driving the second slider 713 to slide to achieve the movement of the door panel 21 relative to the box door 2.

In an embodiment, a first end of the traction rod 709 is rotatably connected to the first shaft fix seat 707 through a pin shaft 708 and a third bearing 715, and a second end of the traction rod 709 is rotatably connected to the second shaft fix seat 710 through another pin shaft 708 and another third bearing 715.

In an embodiment of the present application, as shown in FIG. 4 to FIG. 6, the second slider 713 is provided with a first connect block 712, and the first connect block 712 is formed with a snap slot for hanging the door panel 21.

In this embodiment, by providing the first connect block 712 at the second slider 713 and the snap slot at the first connect block 712, and corresponding connect assemblies (such as hooks, and snap-fit components, etc.) adapted to the snap slot at the door panel 21, the door panel 21 is mounted at the first connect block 712. The door panel 21 may slide with the second slider 713. It is also convenient for users to remove the door panel 21 from the second slider 713 when needed, meeting the usage needs of users in different scenarios.

In an embodiment of the present application, as shown in FIG. 2, FIG. 6 to FIG. 9, the door body assembly further includes a driven slide door mechanism. The driven slide door mechanism is provided at the box door 2, including a second pedestal 817 and a third slider 813. The second pedestal 817 is formed with a third guide rail, the third slider 813 is slidably provided at the third guide rail, the third slider 813 is provided with a second connect block 812, and the second connect block 812 is formed with the snap slot for hanging the door panel 21.

In this embodiment, the box door 2 is provided with the driven slide door mechanism, the driven slide door mechanism having a second pedestal 817. The second pedestal 817 is provided with a third guide rail, and a third slider 813 that may slide along the third guide rail. The third slider 813 is connected to the door panel 21 through the second connect block 812. The third slider 813 may slide along with the door panel 21 when the door panel 21 slides relative to the box door 2, providing support and assistance for sliding of the door panel 21, making it smoother for the door panel 21 to slide relative to the box door 2. The driven slide door mechanism may match with the active slide door mechanism 7 to limit the movement direction of the door panel 21, reducing the shaking of the door panel 21 during sliding and making the sliding more stable. In addition, the snap slot at the second connect block 812 may facilitate users to mount the door panel 21 at the driven slide door mechanism.

In a specific embodiment, there may be a plurality of driven slide door mechanisms, and the plurality of driven slide door mechanisms are respectively provided at different positions at the box door 2, to provide a plurality of auxiliary slide support points for the door panel 21, making it smoother for the door panel 21 to slide relative to the box door 2.

Furthermore, in an embodiment of the present application, as shown in FIG. 6 to FIG. 9, the driven slide door mechanism includes a first driven slide door mechanism 8, and a second driven slide door mechanism 9.

As shown in FIG. 2, FIG. 6, and FIG. 7, the first driven slide door mechanism 8 is coaxially provided with the active slide door mechanism 7. The first driven slide door mechanism 8 includes a second pedestal 817 and a third slider 813. The second pedestal 817 is formed with a third guide rail, and the third slider 813 is slidably provided at the third guide rail. The third slider 813 is provided with a second connect block 812, and the second connect block 812 is formed with the snap slot for hanging the door panel 21.

By coaxially providing the first driven slide door mechanism 8 and the active slide door mechanism 7, the third slider 813 may slide coaxially with the active slide door mechanism 7, better assisting the door panel 21 to slide relative to the box door 2 under the drive of the active slide door mechanism 7. The second connect block 812 may match with the active slide door mechanism 7 to limit the movement direction of the door panel 21, avoiding the swinging of the door panel 21 during movement. The first driven slide door mechanism 8 is coaxially provided with the active slide door mechanism 7, meaning that they share a same centerline or axis. This helps ensure that the door panel 21 may maintain stable linear motion during sliding, reducing the possibility of deviation or swinging. Coaxial providing is used in situations where precise control of motion direction or maintenance of relative positional relationships between parts is required.

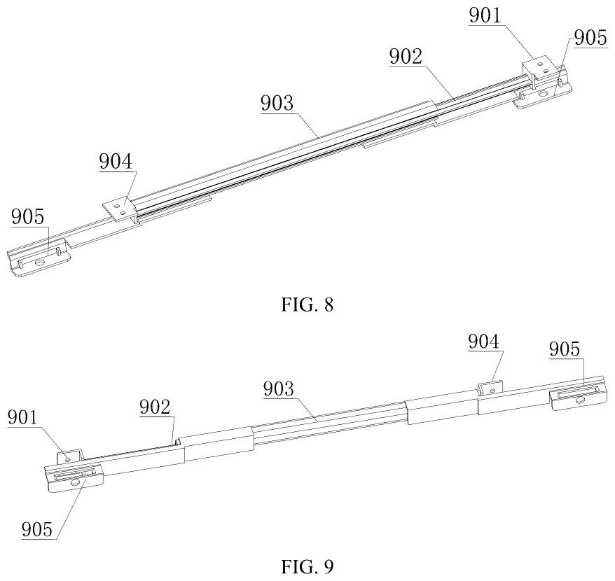

As shown in FIG. 2, FIG. 8, and FIG. 9, the second driven slide door mechanism 9 is non-coaxially provided with the active slide door mechanism 7. The second driven slide door mechanism 9 includes a third pedestal 902 and a fourth slider 903. The third pedestal 902 is formed with a fourth guide rail, and the fourth slider 903 is slidably provided at the fourth guide rail. The fourth slider 903 is provided with a third connect block 905, and the third connect block 905 is formed with a snap slot for hanging the door panel 21.

By providing the second driven slide door mechanism 9, the fourth slider 903 of the second driven slide door mechanism 9 may slide with the door panel 21 when the door panel 21 slides relative to the box door 2, providing support and assistance to the sliding of the door panel 21, making it smoother for the door panel 21 to slide relative to the box door 2.

Due to the non-coaxial providing of the second driven slide door mechanism 9 and the active slide door mechanism 7, the third connect block 905 may match with the active slide door mechanism 7 to limit the movement direction of the door panel 21, avoiding the deviation of the door panel 21 around the sliding direction during sliding, and making sliding more stable and reliable. The second driven slide door mechanism 9 and the active slide door mechanism 7 are non-coaxially provided, which means they do not share the same centerline or axis. This configuration is used to provide additional support and stability, or to prevent the door panel 21 from deviating around the sliding direction during sliding. Non-coaxial providing is used in situations where force dispersion, increased stability, or complex motion trajectories are required.

In an embodiment of the present application, as shown in FIG. 8 and FIG. 9, two ends of the third pedestal 902 of the second driven slide door mechanism 9 are respectively provided with a fifth fix seat 901 and a sixth fix seat 904, which is used for being fixedly connected to the box door 2.

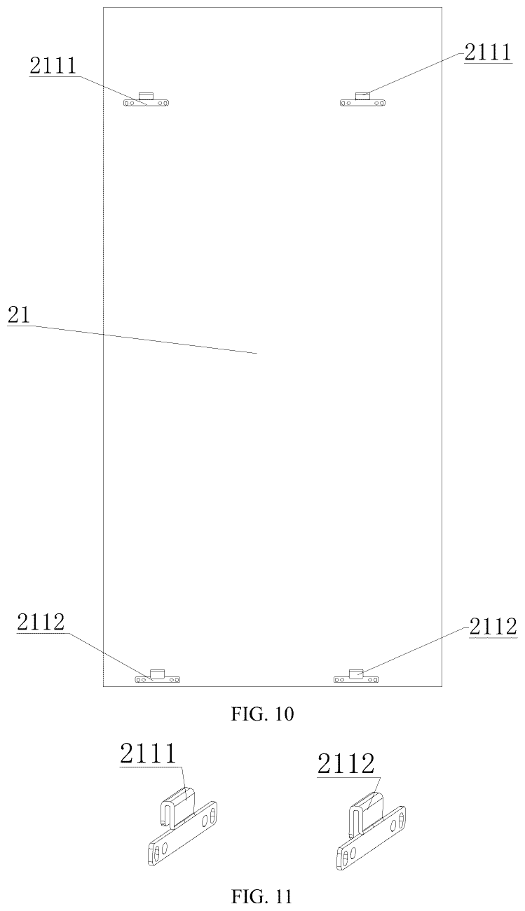

In an embodiment of the present application, as shown in FIG. 10 and FIG. 11, a top of the door panel 21 is provided with a first hook 2111, and a bottom of the door panel 21 is provided with a second hook 2112, a length of the second hook 2112 is greater than a length of the first hook 2111. The first hook 2111 and the second hook 2112 are configured for being inserted into corresponding snap slots.

In this embodiment, by providing the first hook 2111 and the second hook 2112 at the top and the bottom of the door panel 21 respectively, the door panel 21 may be connected to the snap slot of the active slide door mechanism 7 and the snap slot of the driven slide door mechanism through the first hook 2111 and the second hook 2112. The door panel 21 and the box door 2 is slidably connected. The first hook 2111 and the second hook 2112 are located at the top and the bottom of the door panel 21 respectively, to prevent the door panel 21 from shaking easily.

In addition, the length of the second hook 2112 is greater than the length of the first hook 2111. When mounting the door panel 21 at the outer side of the box door 2, the snap slot at the bottom is first hanged to the second hook 2112 of the door panel 21 to preliminarily position the bottom of the door panel 21. Then, the position and angle of the door panel 21 are adjusted. The first hook 2111 at the top of the door panel 21 is inserted into the snap slot at the top of the box door 2, making it easier for users to align the snap slots with the first hook 2111 and the second hook 2112, making mounting more convenient.

In an embodiment, the first hook 2111 includes a connect part and a hook part provided at the connect part. The hook part is in a shape of a hook, and is used for being hanged in the snap slot. The connect part is provided with at least one waist-shaped hole extending horizontally, and at least one waist-shaped hole extending vertically. The door panel 21 is provided with a fix hole corresponding to the first hook 2111. The door panel 21 and the first hook 2111 are fixedly connected through a fixer that passes through the waist-shaped hole and the fix hole. By adjusting a position of the fixer in the waist-shaped hole, a position of the first hook 2111 may be fine adjusted to mount the door panel 21, and the position and angle of the door panel 21 may be fine adjusted.

It may be understood that a structure of the second hook 2112 is similar to a structure of the first hook 2111, and will not be repeated here.

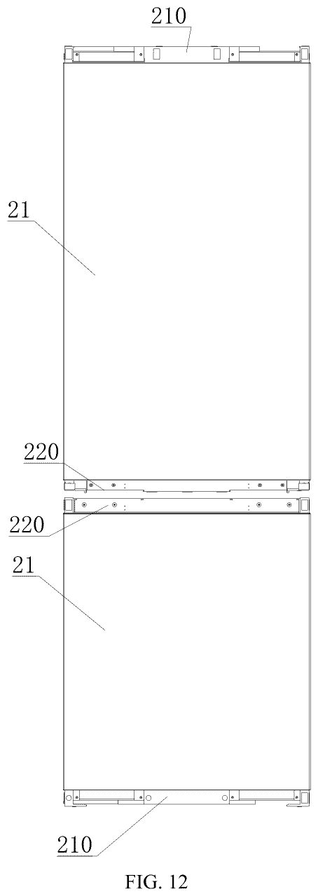

In an embodiment of the present application, as shown in FIG. 12 to FIG. 15, the door body assembly further includes: a first end cover 210, and a second end cover 220. The first end cover 210 is provided at a first end of the box door 2, the first end cover 210 is formed with a first mounting slot 213, and the active slide door mechanism 7 is provided in the first mounting slot 213; the second end cover 220 is provided at a second end of the box door 2, the second end cover 220 is formed with a second mounting slot, and the driven slide door mechanism is provided in the second mounting slot.

In this embodiment, the first end cover 210 and the second end cover 220 are respectively provided at two ends of the box door 2, and the first mounting slot 213 is formed at the first end cover 210 to mount the active slide door mechanism 7. The second mounting slot is formed at the second end cover 220 to mount the driven slide door mechanism, making the structures of the active slide door mechanism 7 and the driven slide door mechanism together with the structure of the box door 2 more compact and aesthetically pleasing.

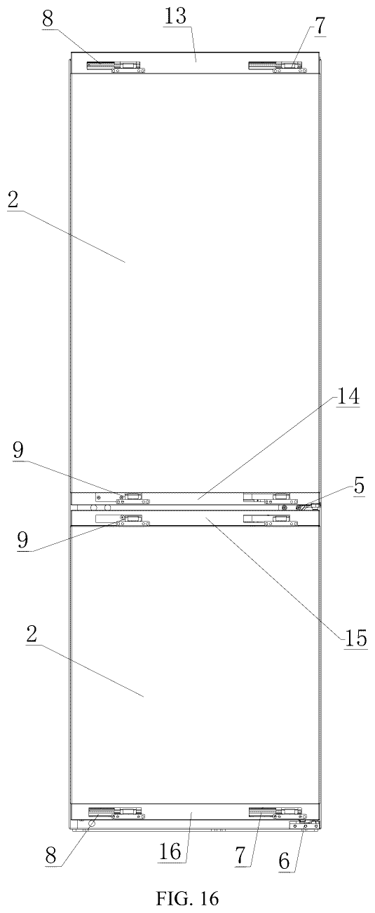

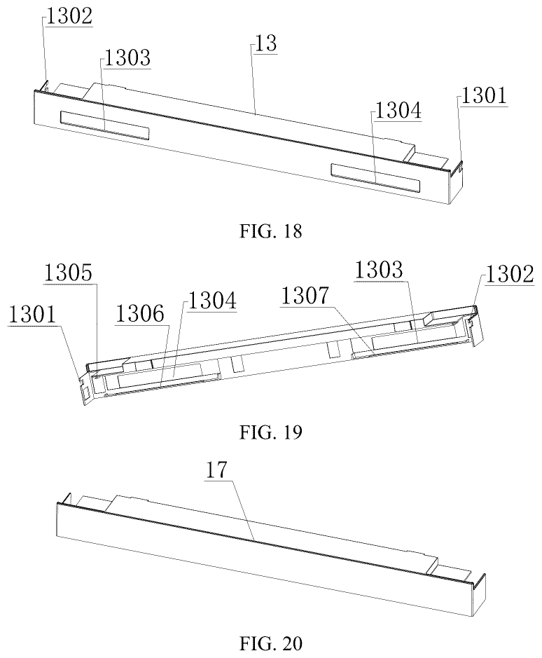

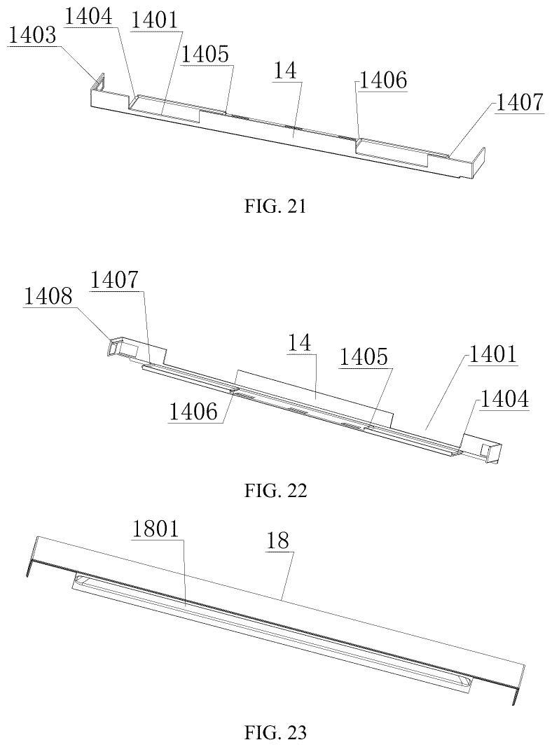

Furthermore, as shown in FIG. 16, FIG. 18, FIG. 19, FIG. 21, and FIG. 22, in an embodiment of the present application, the door body assembly further includes: a first main decorative cover 13, and a second main decorative cover 14. The first main decorative cover 13 is detachably provided at the first end cover 210, formed with a first notch 103, and an end of the first connect block 712 provided with the snap slot passes through the first notch 1303. The second main decorative cover 14 is detachably provided at the second end cover 220, formed with a second notch 1401, and an end of the second connect block 812 with the snap slot passes through the second notch 1401.

In this embodiment, by providing the first main decorative cover 13 at the first end cover 210, the first main decorative cover 13 may cover the entire first end cover 210, avoiding the first mounting slot 213 and the active slide door mechanism 7 from being completely exposed, making it more aesthetically pleasing; the first notch 1303 is formed at the first main decorative cover 13. A snap slot end of the active slide door mechanism 7 may extend to an outer side of the first main decorative cover 13 and connect to the door panel 21, to achieve the function of driving the sliding of the door panel 21. Similarly, by providing a second main decorative cover 14 at the second end cover 220 to cover the entire second end cover 220, the second mounting slot and the driven slide door mechanism are prevented from being exposed, making it more aesthetically pleasing. A snap slot end of the second connect block 812 of the driven slide door mechanism may extend to an outer side of the second main decorative cover 14 through the second notch 1401 at the second main decorative cover 14, and be connected to the door panel 21, to achieve the function of driving the sliding of the door panel 21.

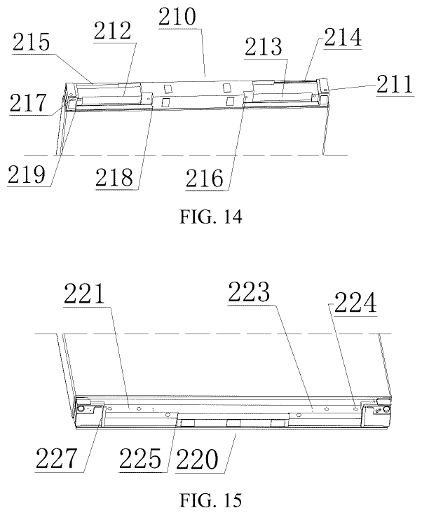

In an embodiment of the present application, as shown in FIG. 14, FIG. 18, and FIG. 19, one of the first main decorative cover 13 and the first end cover 210 is provided with a first protrusion, and another one is provided with a first slot corresponding to the first protrusion. The first main decorative cover 13 is detachably connected to the first end cover 210 through the first protrusion and the first slot.

As shown in FIG. 15, FIG. 21, and FIG. 22, one of the second main decorative cover 14 and the second end cover 220 is provided with a second protrusion, and another one is provided with a second slot corresponding to the second protrusion. The second main decorative cover 14 is detachably connected to the second end cover 220 through the second protrusion and the second slot.

In this embodiment, the first end cover 210 is provided with the first protrusion, and the first main decorative cover 13 is provided with the first slot. The first protrusion and the first slot may be interlocked to fix the first main decorative cover 13 and the first end cover 210 to each other.

It may be understood that positions of the first protrusion and the first slot may be interchanged, that is, the first slot is provided at the first end cover 210, and the first protrusion is provided at the first main decorative cover 13.

Similarly, as shown in FIG. 15, FIG. 21, and FIG. 22, the second end cover 220 is provided with the second protrusion, and the second main decorative cover 14 is provided with the second slot. The second protrusion and the second slot may be interlocked to fix the second main decorative cover 14 and the second end cover 220 to each other.

It may be understood that positions of the second protrusion and the second slot may be interchanged, that is, the first slot is provided at the second end cover 220, and the second protrusion is provided at the second main decorative cover 14.

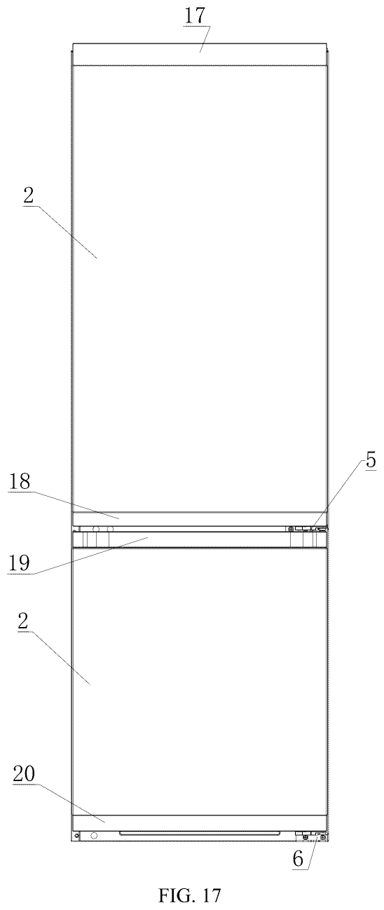

In an embodiment of the present application, as shown in FIG. 17, FIG. 20, and FIG. 23, the door body assembly further includes: a first decorative cover 17, and a second decorative cover 18. The first decorative cover 17 is detachably provided at the first end cover 210 to cover the active slide door mechanism 7; the second decorative cover 18 is detachably provided at the second end cover 220 to cover the driven slide door mechanism.

In this embodiment, in some usage scenarios, the door panel 21 does not need to be provided at the outer side of the box door 2. The first main decorative cover 13 at the first end cover 210 may be replaced with a first secondary decorative cover 17, and the second main decorative cover 14 at the second end cover 220 may be replaced with a second secondary decorative cover 18 to cover the active slide door mechanism 7 and the driven slide door mechanism, to improve the visual consistency of the box door 2, making it more aesthetically pleasing, and meeting different user needs.

Similar to the first main decorative cover 13 and the second main decorative cover 14, the first secondary decorative cover 17 and the second secondary decorative cover 18, and the first end cover 210 and the second end cover 220 may also be snap-fitted through slots and protrusions for easy disassembly and assembly, which will not be repeated here.

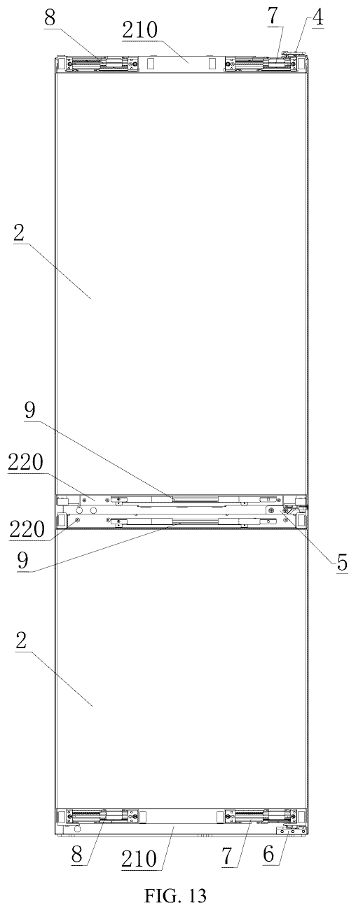

In an embodiment of the present application, as shown in FIG. 2, FIG. 13, and FIG. 14, two ends of the first end cover 210 have first hinge hole 211 rotatably connected to the first hinge 4. The first end cover 210 may be connected to the first hinge 4 through the hinge hole 211 at an end. The first end cover 210 is provided with a first mounting slot 213, and a slot wall of the first mounting slot 213 is provided with a first mounting hole 216. The active slide door mechanism 7 is fixed by bolts through the first mounting hole 216 and the slot wall of the first mounting slot 213. A slot wall of the first mounting slot 213 facing the box body 1 is provided with a first avoidance opening 214 corresponding to the traction mechanism of the active slide door mechanism 7. The traction mechanism of the active slide door mechanism 7 is movably inserted into the first avoidance opening 214 to move with the box door 2 and pull the first slider 714.

The first end cover 210 is further provided with a third mounting slot 212, and the first driven slide door mechanism 8 is mounted in the third mounting slot 212. It may be understood that positions of the active slide door mechanism 7 and the first driven slide door mechanism 8 may be exchanged according to hinge positions of the box door 2 and the box body 1. Correspondingly, a slot wall of the third mounting slot 212 facing the box body 1 is also provided with a second avoidance opening 215, to avoid the traction mechanism of the active slide door mechanism 7.

In an embodiment, two opposite side walls of the first mounting slot 213 and the third mounting slot 212 are provided with a third slot 218 and a fourth slot 219, as well as a first convex edge 217 for insertion, to be mutually inserted and fixed with the first main decorative cover 13 or the first secondary decorative cover 17.

In an embodiment, as shown in FIG. 18 and FIG. 19, end surfaces of the first main decorative cover 13 on two sides are respectively provided with a first notch 1303 and a third notch 1304 corresponding to the first mounting slot 213 and the third mounting slot 212, facilitating the first connect block 712 and the second connect block 812 of the active slide door mechanism 7 and the first driven slide door mechanism 8 to extend the notch and to be connected to the door panel 21. Two ends of the first main decorative cover 13 are provided with a fourth notch 1302 and a fifth notch 1301, facilitating the traction mechanism of the active slide door mechanism 7 to swing when it is mounted in the first mounting slot 213 or the third mounting slot 212, with the movement of the box door 2. The first main decorative cover 13 is provided with a first snap-fit slot 1305 corresponding to the first convex edge 217; an inner side of the first notch 1303 is provided with a first convex rib 1307 for snap-fitting with a slot wall of the first mounting slot 213; an inner side of the third gap 1304 is provided with a second convex rib 1306 for snap-fitting with a slot wall of the third mounting slot 212.

Correspondingly, a structure of the first decorative cover 17 is similar to a structure of the first main decorative cover 13, but a notch for the first connect block 712 and the second connect block 812 to extend out is not provided, which will not be repeated here.

A inner wall of the second mounting slot of the second end cover 220 is provided with a third mounting hole 224, and the guide rail fix seat 221 is mounted in the second mounting slot through the third mounting hole 224. The guide rail fix seat 221 is provided with a second mounting hole 223, and the second driven slide door mechanism 9 is provided at the guide rail fix seat 221 through the second mounting hole 223.

In an embodiment, two opposite side walls of the second mounting slot are provided with a second convex edge 225 and a third convex edge 227 for insertion, to be mutually inserted and fixed with the second main decorative cover 14 or the second secondary decorative cover 18.

In an embodiment, as shown in FIG. 8, FIG. 9, FIG. 21, and FIG. 22, two third connect blocks 905 are provided. Correspondingly, two second notches 1401 are provided at the second main decorative cover 14 corresponding to the two third connect blocks 905. A cavity is formed inside the second main decorative cover 14 for covering the second end cover 220. Two ends of the cavity are provided with a fourth convex edge 1403 and a fifth convex edge 1408, and a bottom of the cavity is provided with a sixth convex edge 1404 and a seventh convex edge 1407, for assembly and match with the third convex edge 227 at the second end cover 220; the bottom of the cavity is also provided with a second snap-fit slot 1405 and a third snap-fit slot 1406 that match and insert with the second convex edge 225, to assemble the second end cover 220 and the second main decorative cover 14 together.

It may be understood that, as shown in FIG. 23, when the door panel 21 does not need to be mounted, the second driven slide door mechanism 9 in the second mounting slot may be removed. Correspondingly, the second secondary decorative cover 18 is provided with a concave handle part 1801 corresponding to the position of the second mounting slot, which facilitates users to manually open and close the box door 2.

In an embodiment of the present application, as shown in FIG. 3, FIG. 4, and FIG. 5, the connector 706 includes: a first connector and a second connector. The first connector passes around a first end of the first pedestal 717 and is connected to a first end of the first slider 714 and a first end of the second slider 713 at two ends; the second connector passes around a second end of the first pedestal 717 and is connected to a second end of the first slider 714 and a second end of the second slider 713 at two ends.

In this embodiment, by connecting the end of the first connector passing around the first pedestal 717 to the first slider 714 and the second slider 713 respectively, when the first slider 714 slides in the direction away from the end of the first pedestal 717 under the drive of the box body 1 and the traction mechanism, the first slider 714 drives the second slider 713 to slide in the direction toward the end of the first pedestal 717 through the first connector; by connecting the another end of the second connector passing around the first pedestal 717 to the first slider 714 and the second slider 713 respectively, when the first slider 714 slides in the direction away from the another end of the first pedestal 717 under the drive of the box body 1 and the traction mechanism, the first slider 714 drives the second slider 713 to slide in the direction toward the another end of the first pedestal 717 through the second connector. This achieves that when the first slider 714 slides toward two ends of the first pedestal 717 respectively, the first slider 714 may drive the second slider 713 to slide in the opposite direction of the first slider 714. The door panel 21 may slide relative to the box door 2 with the rotation of the box door 2 when the box door 2 is opened and closed, to avoid interference with obstacles and affect the opening and closing of the box door 2.

In an embodiment, both the second slider 713 and the first slider 714 are provided with a connect head 711 for fixing the connector 706.

In an embodiment of the present application, as shown in FIG. 3, FIG. 4, and FIG. 5, the active slide door mechanism 7 further includes: a first fix seat 701 and a second fix seat 702. The first fix seat 701 is connected to a first end of the first pedestal 717, formed with a first limit slot. Two ends of the first limit slot are docked with a first end of the first guide rail and a first end of the second guide rail. A part of the first connector is slidably provided in the first limit slot; the second fix seat 702 is connected to a second end of the first pedestal 717, formed with a second limit slot. Two ends of the second limit slot are docked with a second end of the first guide rail and a second end of the second guide rail. A part of the second connector is slidably provided in the second limit slot.

In this embodiment, by providing the first fix seat 701 and the second fix seat 702 at two ends of the first pedestal 717 respectively, the first fix seat 701 and the second fix seat 702 are formed with the first limit slot and the second limit slot docked with the first guide rail and the second guide rail respectively, to limit and guide positions of the first connector and the second connector, making the sliding of the first connector and the second connector smoother.

In an embodiment, the first fix seat 701 is provided with a first fix hole, and the first pedestal 717 is provided with a first waist-shaped hole extending along the width direction of the first pedestal 717; the active slide door mechanism 7 further includes a first adjuster 704, and the first adjuster 704 passes through the first fix hole, and is slidably provided in the first waist-shaped hole, to adjust the tightness of the first connector by adjusting a position of the first adjuster 704 in the first waist-shaped hole.

In this embodiment, by adjusting the position of the first adjuster 704 in the first waist-shaped hole, the position of the first fix seat 701 may be adjusted along the width direction of the first pedestal 717. The first fix seat 701 may tension or relax the first connector, adjusting the tightness of the first connector.

Due to the fact that the first connector and the second connector are respectively located at the first fix seat 701 and the second fix seat 702 at both sides of the first pedestal 717, and the first connector and the second connector are connected to the two ends of the first slider 714 and the second slider 713, when adjusting the movement of the first fix seat 701 relative to the first pedestal 717 through the first waist-shaped hole, the first connector correspondingly adjusts the tightness, and the second connector also adjusts the tightness under pulling of the first connector by the first fix seat 701.

It may be understood that a first fix hole may also be provided at the second fix seat 702; the first pedestal 717 is provided with a first waist-shaped hole extending along the width direction of the first pedestal 717; the active slide door mechanism 7 further includes a first adjuster 704, and the first adjuster 704 passes through the first fix hole, and is slidably provided in the first waist-shaped hole, to adjust the tightness of the second connector by adjusting a position of the first adjuster 704 in the first waist-shaped hole.

In this embodiment, by adjusting the position of the first adjuster 704 in the first waist-shaped hole, the position of the second fix seat 702 may be adjusted along the width direction of the first pedestal 717. The second fix seat 702 may tension or relax the second connector, adjusting the tightness of the second connector.

Due to the fact that the first connector and the second connector are respectively located at the first fix seat 701 and the second fix seat 702 at both sides of the first pedestal 717, and the first connector and the second connector are connected to the two ends of the first slider 714 and the second slider 713, when adjusting the movement of the second fix seat 702 relative to the first pedestal 717 through the first waist-shaped hole, the second connector correspondingly adjusts the tightness, and the first connector also adjusts the tightness under pulling of the second connector by the second fix seat 702.

Furthermore, in some embodiments, the first fix seat 701 is provided with a second waist-shaped hole extending along the width direction of the first pedestal 717. The first pedestal 717 is provided with a second fix hole. The active slide door mechanism 7 further includes a second adjuster 703, and the second adjuster 703 sequentially passes through the second waist-shaped hole and the second fix hole, and is fixed in an external structure, to adjust a position of the first fix seat 701 relative to the external structure through a position of the second adjuster 703 in the second waist-shaped hole.

In this embodiment, by providing a second waist-shaped hole at the first fix seat 701, and making the second adjuster 703 sequentially passing through the second waist-shaped hole and the second fix hole to be fixed in the external structure, the first fix seat 701 is fixed in the external structure, and the active slide door mechanism 7 is fixed at the external structure (such as the box door 2). The second adjuster 703 may be fine adjusted along the position of the second waist-shaped hole to adjust the position of the first fix seat 701, to match with the adjustment of the position of the first fix seat 701 relative to the external structure.

It may be understood that the second fix seat 702 may be also provided a second waist-shaped hole extending along the width direction of the first pedestal 717; the second adjuster 703 sequentially passes through the second waist-shaped hole and the second fix hole, and is fixed in the external structure, to adjust the position of the second fix seat 702 relative to the external structure according to through the position of the second adjuster 703 in the second waist-shaped hole. Functions of the second adjuster 703, the second waist-shaped hole, and the second fix hole are similar to those of the above embodiments, and will not be repeated here.

Furthermore, in some embodiments, the first limit slot is provided with a rotatable support bearing; a part of the first connector is in contact with the support bearing in the first limit slot. In this embodiment, a part of the first connector is in contact with the support bearing to adjust the movement and extension direction of the first connector, facilitating passing the first connector around the end of the first pedestal 717 to connect the first slider 714 and the second slider 713.

It may be understood that a rotatable support bearing may also be provided in the second limit slot; a part of the second connector is in contact with the support bearing in the second limit slot, to adjust the extension direction of the second connector, and facilitate passing the second connector around the end of the first pedestal 717 to connect the first slider 714 and the second slider 713.

In an embodiment, the support bearing includes a first bearing 705 and a second bearing 716, with the first bearing 705 and the second bearing 716 located at an end of the first guide rail and the second guide rail at a same side respectively, and at two sides of the first pedestal 717 respectively.

In an embodiment of the present application, as shown in FIG. 6 and FIG. 7, the first driven slide door mechanism 8 may be configured with a similar structure as the active slide door mechanism 7, and may be interchanged with the active slide door mechanism 7 when necessary.

In an embodiment, the first driven slide door mechanism 8 includes a second pedestal 817 and a third slider 813. A side of the second pedestal 817 is formed with a third guide rail. The third slider 813 is slidably provided at the third guide rail. The third slider 813 is provided with a second connect block 812, and the second connect block 812 is formed with the snap slot for hanging the door panel 21.

Furthermore, the first driven slide door mechanism 8 further includes a third fix seat 801 and a fourth fix seat 802. The third fix seat 801 and the fourth fix seat 802 are also provided with a limit slot similar to the limit slot of the first fix seat 701 and the second fix seat 702.

In an embodiment, the third fix seat 801 is provided with a third fix hole, and the second pedestal 817 is provided with a third waist-shaped hole extending along the width direction of the second pedestal 817; the third adjuster 804 passes through the third fix hole, and is slidably provided in the third waist-shaped hole, to adjust a position of the third adjuster 804 in the third waist-shaped hole.

It may be understood that a third fix hole may also be provided at the fourth fix seat 802; the second pedestal 817 is provided with a third waist-shaped hole extending along the width direction of the second pedestal 817; the third adjuster 804 passes through the third fix hole, and is slidably provided in the third waist-shaped hole, to adjust the position of the third adjuster 804 in the third waist-shaped hole

Furthermore, the third fix seat 801 is provided with a fourth waist-shaped hole extending along the width direction of the second pedestal 817. The second pedestal 817 is provided with a fourth fix hole. The fourth adjuster 803 sequentially passes through the fourth waist-shaped hole and the fourth fix hole, and is fixed in the external structure, to adjust the position of the third fix seat 801 relative to the external structure through a position of the fourth adjuster 803 in the fourth waist-shaped hole.

It may be understood that the fourth fix seat 802 may be also provided with a fourth waist-shaped hole extending along the width direction of the third pedestal 902; the fourth adjuster 803 sequentially passes through the fourth waist-shaped hole and the fourth fix hole, and is fixed in the external structure, to adjust a position of the fourth fix seat 802 relative to the external structure through the position of the fourth adjuster 803 in the fourth waist-shaped hole.

In another embodiment of the present application, as shown in FIG. 1 and FIG. 2, a refrigeration device is provided, including: a box body 1, and the door body assembly provided in any of the above embodiments. The box body 1 is formed with a storage space, the box door 2 is rotatably connected to the box body 1, and is configured to open or close the storage space.

In this embodiment, the door body assembly includes: a box door 2, a door panel 21, and an active slide door mechanism 7. The active slide door mechanism 7 is provided at the box door 2, and is configured to drive the door panel 21 to move relative to the width direction of the box door 2 during opening or closing of the box door 2.

By providing the door panel 21 at the box door 2, when the refrigeration device is embedded and provided in a slot-shaped space, or between two cabinets bodies, the door panel 21 may be provided at a side wall of the slot or flush with the cabinet at two sides, to reduce the gap between the refrigeration device and the adjacent wall or cabinet body, making it more aesthetically pleasing.

When the box door 2 rotates, the active slide door mechanism 7 may drive the door panel 21 to move relative to the box door 2 during the rotation of the box door 2, to move away from obstacles such as walls or cabinet bodies at the side door of the box body 1 as much as possible, to avoid these obstacles blocking the door panel 21 and affecting the rotation of the box door 2, resulting in the box door 2 being unable to open or close normally.

The combination of the box door 2 and door panel 21 enables the refrigeration device to avoid interference between the door panel 21 and surrounding objects when opening and closing, greatly improving the convenience of use. Especially in narrow kitchen environments, this design advantage is even more pronounced. In addition, the providing of the active slide door mechanism 7 enables the door panel 21 to move smoothly during opening and closing, improving the service life and stability of a refrigerator.

It may be understood that the door body assembly has the beneficial effects of the above embodiments, the refrigeration device will correspondingly have the beneficial effects of the above embodiments. The specific implementation method may refer to the above embodiments, and the present application will not repeat it.

As shown in FIG. 1, an application scenario based on the above embodiment is as follows: the refrigeration device may be mounted in a slot-shaped structure in the middle of a cabinet body. The outer side of the box door 2 of the box body 1 of the refrigeration device is provided with the door panel 21, and the material and color of the door panel 21 may be designed to be similar or the same as the material and color of the outer wall of the cabinet body. When the box door 2 is closed, the door panel 21 is flush with an outer wall of the cabinet body at an edge of the slot-shaped opening, and is as close as possible to the slot-shaped opening. The door panel 21 and the outer wall of the cabinet body may maintain visual consistency and have a smaller gap, making it more aesthetically pleasing.

When the box door 2 rotates outward and opens, the active slide door mechanism 7 drives the door panel 21 to slide in the direction away from the first hinge 4, to avoid interference between the door panel 21 and the cabinet wall near the first hinge 4, which may prevent the box door 2 from opening to a larger angle. When the box door 2 rotates and closes, the active slide door mechanism 7 drives the door panel 21 to slide in the direction toward the first hinge 4, to avoid interference between the door panel 21 and the cabinet wall at a side away from the first hinge 4, which may cause the box door 2 unable to be fully closed and affect the refrigeration and storage effect in the storage space. Moreover, when the box door 2 is completely closed, the door panel 21 may return to a state flush with the cabinet body.

In an embodiment, the box body 1 may have one or more storage spaces, each storage space with a corresponding door body assembly. It may be understood that a plurality of storage spaces may be provided in any way, such as top-bottom configuration, and left-right configuration, etc.

In an embodiment of the present application, as shown in FIG. 1 and FIG. 2, the box body 1 has a first storage space and a second storage space. Correspondingly, the door body assembly further includes a first door body assembly and a second door body assembly. The box door 2 of the first door body assembly is rotatably connected to the box body 1, to open or close the first storage space, and the box door 2 of the second door body assembly is rotatably connected to the box body 1 to open or close the second storage space.

Furthermore, the first storage space and the second storage space are provided in sequence along a height direction of the box body 1.

Furthermore, the first door body assembly further includes a first driven slide door mechanism 8 and a second driven slide door mechanism 9. The second door body assembly further includes a first driven slide door mechanism 8 and a second driven slide door mechanism 9. The active slide door mechanism 7 and the first driven slide door mechanism 8 of the first door body assembly are provided at the top of the corresponding box door 2, and the second driven slide door mechanism 9 of the first door body assembly is provided at the bottom of the corresponding box door 2; the active slide door mechanism 7 and the first driven slide door mechanism 8 of the second door body assembly are located at the bottom of the corresponding box door 2, and at the top of the second driven slide door mechanism 9 of the first door body assembly.

In an embodiment, the box body 1 is provided with a first connect hole 110, and the first hinge 4 is connected to the first connect hole 110 of the box body 1. The box body 1 is rotatably connected to the box door 2 of the first door body assembly through the first hinge 4.

The first storage space and the second storage space are separated by a first beam body 120, and the first beam body 120 is provided with a second connect hole 121. The first beam body 120 is connected to the second hinge 5 through the second connect hole 121. The second hinge 5 has two hinge shafts distributed vertically, and the two hinge shafts are respectively rotatably connected to the box door 2 of the first door body assembly and the box door 2 of the second door body assembly.

The bottom of the second storage space is provided with a second beam body 130, and the second beam body 130 is provided with a third connect hole 132 and a fourth connect hole 131. The second beam body 130 passes through the third connect hole 132 and the third hinge 6, and is rotatably connected to the box door 2 of the second door body assembly through the third hinge 6. The second beam body 130 is connected to the active slide door mechanism 7 of the second door body assembly through the fourth connect hole 131.

The top and the bottom of the box door 2 of the first door body assembly are respectively provided with a first end cover 210 and a second end cover 220. The first end cover 210 is rotatably connected to the first hinge 4, and the second end cover 220 is rotatably connected to the hinge shaft located at an upper side of the second hinge 5, to achieve the rotation of the box door 2 of the first door body assembly relative to the box body 1.

The top and the bottom of the box door 2 of the second door body assembly are respectively provided with a second end cover 220 and a first end cover 210. The first end cover 210 is rotatably connected to the third hinge 6, and the second end cover 220 is rotatably connected to the hinge shaft located at the lower side of the second hinge 5, to achieve the rotation of the box door 2 of the second door body assembly relative to the box body 1.

In an embodiment, as shown in FIG. 2, FIG. 18 to FIG. 23, the first door body assembly further includes a first main decorative cover 13, a second main decorative cover 14, a first secondary decorative cover 17, and a second secondary decorative cover 18.

The first main decorative cover 13 is provided with a first notch 1303 for an end of the first connect block 712 with a snap slot to pass through. Both the first main decorative cover 13 and the first secondary decorative cover 17 may be detachably mounted at the first end cover 210 of the first door body assembly. Users may disassemble the door panel 21 according to the usage scenario of the refrigeration device and switch between the first main decorative cover 13 and the first secondary decorative cover 17.

In an embodiment, when there is need to mount the door panel 21, the first main decorative cover 13 may be mounted at the first end cover 210. The active slide door mechanism 7 at the first end cover 210 may be connected to the door panel 21 through the first notch 1303; when there is no need to mount the door panel 21, the first main decorative cover 13 may be removed, and the first secondary decorative cover 17 may be mounted at the first end cover 210.

Similarly, the second main decorative cover 14 is provided with a second notch 1401 for an end of the second connect block 812 with a snap slot to pass through. Both the second main decorative cover 14 and the second secondary decorative cover 18 may be detachably mounted at the second end cover 220 of the second door body assembly. Users may disassemble the door panel 21 according to the usage scenario of the refrigeration device and switch between the second main decorative cover 14 and the second secondary decorative cover 18.

In an embodiment, when there is need to mount the door panel 21 of the first door body assembly, the second main decorative cover 14 may be mounted at the second end cover 220, and the driven slide door mechanism at the second end cover 220 may be connected to the door panel 21 through the second notch 1401; when there is no need to mount the door panel 21, the second main decorative cover 14 may be removed, and the second secondary decorative cover 18 may be mounted at the second end cover 220.

Similarly, as shown in FIG. 2, the second door body assembly further includes a third main decorative cover 15, a fourth main decorative cover 16, a third secondary decorative cover 19, and a fourth secondary decorative cover 20.

The third main decorative cover 15 and the third secondary decorative cover 19 are used for detachable mounting with the second end cover 220 at the top of the second door body assembly. It may be understood that a structure of the third main decorative cover 15 is similar to a structure of the second main decorative cover 14; a structure of the third decorative cover 19 is similar to a structure of the second decorative cover 18.

The fourth main decorative cover 16 and the fourth secondary decorative cover 20 are used for detachable mounting with the first end cover 210 at the bottom of the second door body assembly. It may be understood that a structure of the fourth main decorative cover 16 is similar to a structure of the first main decorative cover 13; a structure of the fourth decorative cover 20 is similar to a structure of the first decorative cover 17.

In an embodiment, when there is need to mount the door panel 21 of the second door body assembly, the third main decorative cover 15 and the fourth main decorative cover 16 may be mounted at the second end cover 220 and the first end cover 210 respectively; when there is no need to mount the door panel 21, the third main decorative cover 15 and the fourth main decorative cover 16 may be removed, and the third secondary decorative cover 19 and the fourth main decorative cover 16 may be mounted at the second end cover 220 and the first end cover 210 respectively.

Finally, it should be noted that the above embodiments are only used to illustrate the present application and not to limit it. Although the present application has been described in detail with reference to the embodiments, those skilled in the art should understand that various combinations, modifications, or equivalent substitutions of the technical solution of the present application do not depart from the scope of the technical solution of the present application, and should be included in the scope of the claims of the present application.

1. A door body assembly for use in a refrigeration device, and the refrigeration device comprises a box body;
the door body assembly comprises:
a box door, rotatably connected to the box body, and configured to open or close a storage space of the box body;
a door panel, slidably provided at an outer side of the box door; and
an active slide door mechanism and a traction mechanism, wherein the active slide door mechanism is provided at the box door, the active slide door mechanism is drivingly connected to the box body through the traction mechanism, and the active slide door mechanism is drivingly connected to the door panel; during opening or closing of the box door, the box body drives the active slide door mechanism through the traction mechanism, and the active slide door mechanism drives the door panel to slide in a width direction of the box door.

2. The door body assembly of claim 1, wherein the active slide door mechanism comprises:
a first pedestal, with a first guide rail formed at one side and a second guide rail formed at another side;
a first slider, drivingly connected to the box body through the traction mechanism and slidably provided at the first guide rail;
a second slider connected to the door panel and slidably provided at the second guide rail; and
a connector with two ends respectively connected to the first slider and the second slider;
during opening or closing of the box door, the box body drives the first slider to move at the first guide rail through the traction mechanism, and the first slider drives the second slider to move in an opposite direction at the second guide rail through the connector, to drive the door panel to move relative to the box door.

3. The door body assembly of claim 2, wherein the second slider is provided with a first connect block, and the first connect block is formed with a snap slot for hanging the door panel.

4. The door body assembly of claim 3, wherein the door body assembly further comprises:
a driven slide door mechanism, provided at the box door and comprising a second pedestal and a third slider;
wherein the second pedestal is formed with a third guide rail, the third slider is slidably provided at the third guide rail, the third slider is provided with a second connect block, and the second connect block is formed with the snap slot for hanging the door panel.

5. The door body assembly of claim 4, wherein a top of the door panel is provided with a first hook, a bottom of the door panel is provided with a second hook, and a length of the second hook is greater than a length of the first hook; the first hook and the second hook are configured for being inserting into corresponding snap slots.

6. The door body assembly of claim 4, wherein the door body assembly further comprises:
a first end cover provided at a first end of the box door, wherein the first end cover is formed with a first mounting slot and the active slide door mechanism is provided in the first mounting slot; and
a second end cover, provided at a second end of the box door, wherein the second end cover is formed with a second mounting slot, and the driven slide door mechanism is provided in the second mounting slot.

7. The door body assembly of claim 6, wherein the door body assembly further comprises:
a first main decorative cover, wherein the first main decorative cover is detachably provided at the first end cover and is formed with a first notch, and an end, provided with the snap slot, of the first connect block passes through the first notch; and
a second main decorative cover, wherein the second main decorative cover is detachably provided at the second end cover and formed with a second notch, and an end, provided with the snap slot passes, of the second connect block passes through the second notch.

8. The door body assembly of claim 7, wherein one of the first main decorative cover and the first end cover is provided with a first protrusion, the other one is provided with a first slot corresponding to the first protrusion, and the first main decorative cover is detachably connected to the first end cover through the first protrusion and the first slot; and
one of the second main decorative cover and the second end cover is provided with a second protrusion, the other one is provided with a second slot corresponding to the second protrusion, and the second main decorative cover is detachably connected to the second end cover through the second protrusion and the second slot.

9. The door body assembly of claim 2, wherein the connector comprises:
a first connector, wherein the first connector passes around a first end of the first pedestal and is connected to a first end of the first slider and a first end of the second slider at two ends respectively; and
a second connector, wherein the second connector passes around a second end of the first pedestal and is connected to a second end of the first slider and a second end of the second slider at two ends respectively.

10. A refrigeration device, comprising:
a box body, formed with a storage space; and
the door body assembly of claim 1, wherein the box door is rotatably connected to the box body, and is configured to open or close the storage space.
